(19) United States
(12) Patent Application Publication
(10) Pub. No.: US 2016/0266601 A1
(43) Pub. Date: Sep. 15, 2016

(54) MAGNETIC ROTATION RESTRICTING DEVICE

(71) Applicants: Bo Christensen, Nordborg (DK); 9. Solutions Technology Co., Limited, Hong Kong (CN)

(72) Inventor: Bo CHRISTENSEN, Nordborg (DK)

(21) Appl. No.: 14/706,089

(22) Filed: May 7, 2015

(30) Foreign Application Priority Data
Mar. 11, 2015 (TW) 104203585

(51) Int. Cl. G05G 5/04; F16M 11/08; G05G 5/12

(52) U.S. Cl. CPC G05G 5/04; G05G 5/12; F16M 11/08

(57) ABSTRACT

A magnetic rotation restricting device includes a support unit, a rotary unit, a magnetic unit enabling the support unit and the rotary unit to be magnetically attracted to each other; and a restricting unit. With the arrangement of magnetic attraction, and the engagement of the toothed portions and the threaded portion, and the restricted space, the structure of the magnetic rotation restricting device is very stable, and therefore suitable for use in an assembly member which needs to be used under high speed environment (such as extreme sports). Besides, only the restricting unit needs to be released when adjusting the angle of the assembly member, and a restricting force (the magnetic force) will be produced during angle adjustment to prevent inertia-caused uncontrolled rotation of the assembly member, so as to enhance the precision of adjustment.

### CROSS REFERENCE TO RELATED APPLICATION

This application claims the benefit of priority to TW 104203585, filed on Mar. 11, 2015 with the Intellectual Property Office of the Republic of China,

Taiwan, the entire specification of which is incorporated herein by reference.

### BACKGROUND OF THE INVENTION

1. Field of the Invention

The present invention relates to a restricting device, and more particularly to a magnetic rotation restricting device.

2. Description of the Prior Art

A coupling (joint) device is usually used to couple a support A and an assembly member B, and generally includes universal (rotary) coupling which allows for rotation of the assembly member B, and non-rotary coupling.

The assembly member B is a digital adapter, and the support A is a tripod, for example. As shown in FIG. 1, the coupling structure for coupling the support A and the assembling member is provided with a socket A1 at the top of the support A, and a rotary member A2 rotatably disposed in the socket A1. The rotary member A2 can be a rod with an axis X and screwed to the assembly member B. To lock the position of the rotary member A2 with respect to the socket Al, a screw C is inserted into the socket A1 to press against the rotary member A2, so as to fix the positions of the rotary member A2 and the assembly member B thereon.

However, the screw C is very likely to get loose when used in an environment of high frequent vibration, causing failure and ineffectiveness of the coupling structure.

Furthermore, when the screw C is released to adjust the position of the assembly member B, the rotary member A2 will be freely rotatable. If it is not used in a static environment (such as extreme sports), the assembly member B will be caused to rotate and move from its original position due to the inertia effect caused by fast motion of the user. The user has to stop moving and readjust the position of the assembly member B, which is very inconvenient.

The present invention has arisen to mitigate and/or obviate the afore-described disadvantages.

### SUMMARY OF THE INVENTION

The primary objective of the present invention is to provide a magnetic rotation restricting device which is capable of overcoming the above mentioned problems.

To achieve the above objective, a magnetic rotation restricting device in accordance with the present invention comprises:

a support unit with a support surface formed at one end thereof, and a threaded surface connected to the support surface, the support surface being provided with an annular toothed portion, and the threaded surface is formed with a thread, another end of the support unit being connected to a support member;

a rotary unit including one end formed with an annular flange which includes an abutting surface and an opposite connecting surface, the connecting surface being provided with an annular toothed portion for meshing with the toothed portion of the support unit, an assembly member being mounted at another end of the rotary unit, the connecting surface of the rotary unit being located toward the support surface of the support unit;

a magnetic unit enabling the support unit and the rotary unit to be magnetically attracted to each other; and

a restricting unit being an annular structure with an outer peripheral surface and an inner peripheral surface, the inner peripheral surface being circularly shaped and including a threaded section, a transition section and a stop section connected with one another, the threaded section being meshed with the threaded surface of the support unit, and the stop section being smaller in inner diameter than the threaded section, the restricting unit has the inner peripheral surface adjacent to the end of the threaded section sleeved onto the rotary unit and then sleeved onto the support unit to make the threaded section meshed with thread of the threaded surface, rotating the restricting unit makes the stop section move toward the rotary unit until the stop section stops against the abutting surface of the rotary unit.

With the arrangement of magnetic attraction, and the engagement of the toothed portions and the threaded portion, and the restricted space, the structure of the magnetic rotation restricting device in accordance with the present invention is very stable, and is therefore suitable for use in the assembly member B which needs to be used under high speed environment (such as extreme sports). Besides, only the restricting unit needs to be released in order to adjust the angle of the assembly member, and a restricting force (the magnetic force) will be produced during angle adjustment to prevent inertia-caused uncontrolled rotation of the assembly member B, so as to enhance the precision of adjustment.

### BRIEF DESCRIPTION OF THE DRAWINGS

FIG. 1 is a side view of a conventional coupling device;

FIG. 2 is an exploded view of a magnetic rotation restricting device in accordance with a first preferred embodiment of the present invention;

FIG. 3 is an assembly view of the magnetic rotation restricting device in accordance with the first embodiment of the present invention;

FIG. 4 is a cross sectional view of the magnetic rotation restricting device in accordance with the first embodiment of the present invention;

FIG. 5 is an exploded view of a magnetic rotation restricting device in accordance with a second preferred embodiment of the present invention;

FIG. 6 is an assembly view of the magnetic rotation restricting device in accordance with the second preferred embodiment of the present invention;

FIG. 7 is a cross sectional view of the magnetic rotation restricting device in accordance with the second preferred embodiment of the present invention;

FIG. 8 is an illustrative view showing that the magnetic rotation restricting device in accordance with the second preferred embodiment of the present invention is assembled to a component;

FIG. 9 is another cross sectional view of the magnetic rotation restricting device in accordance with the second preferred embodiment of the present invention;

FIG. 10 shows that the magnetic rotation restricting device in accordance with the second preferred embodiment of the present invention has been adjusted an angle;

FIG. 11 is an exploded view of a magnetic rotation restricting device in accordance with a third preferred embodiment of the present invention; and

FIG. 12 is a cross sectional view of the magnetic rotation restricting device in accordance with the third preferred embodiment of the present invention.

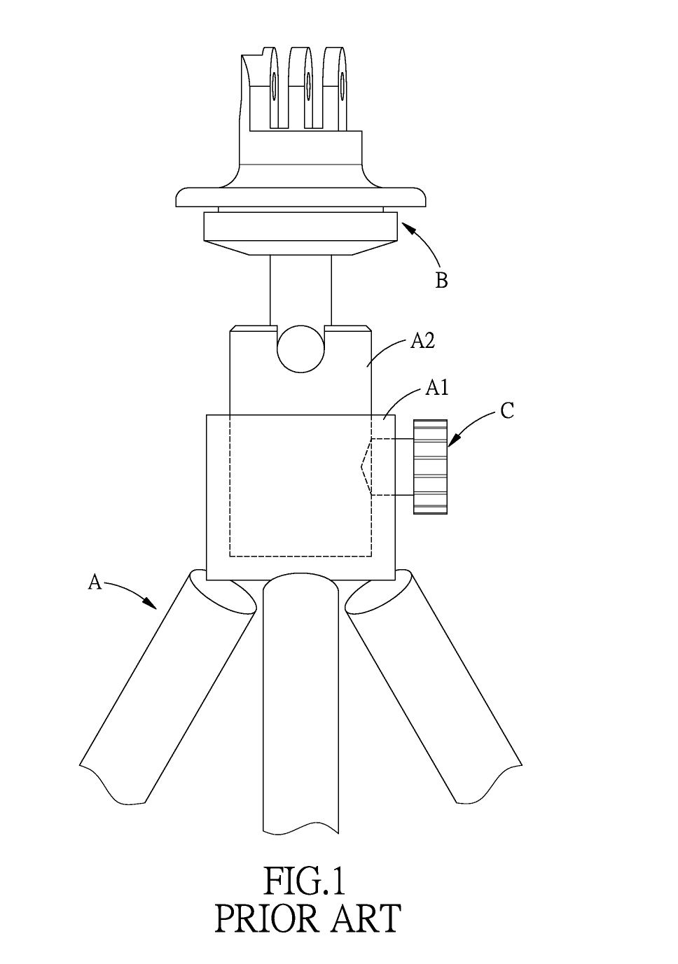

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

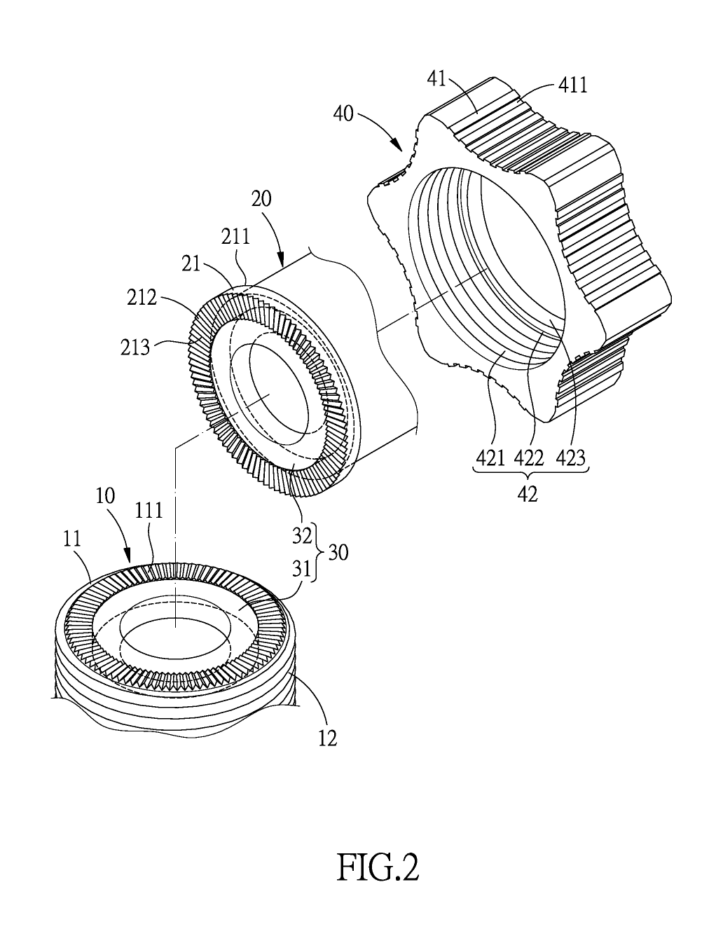

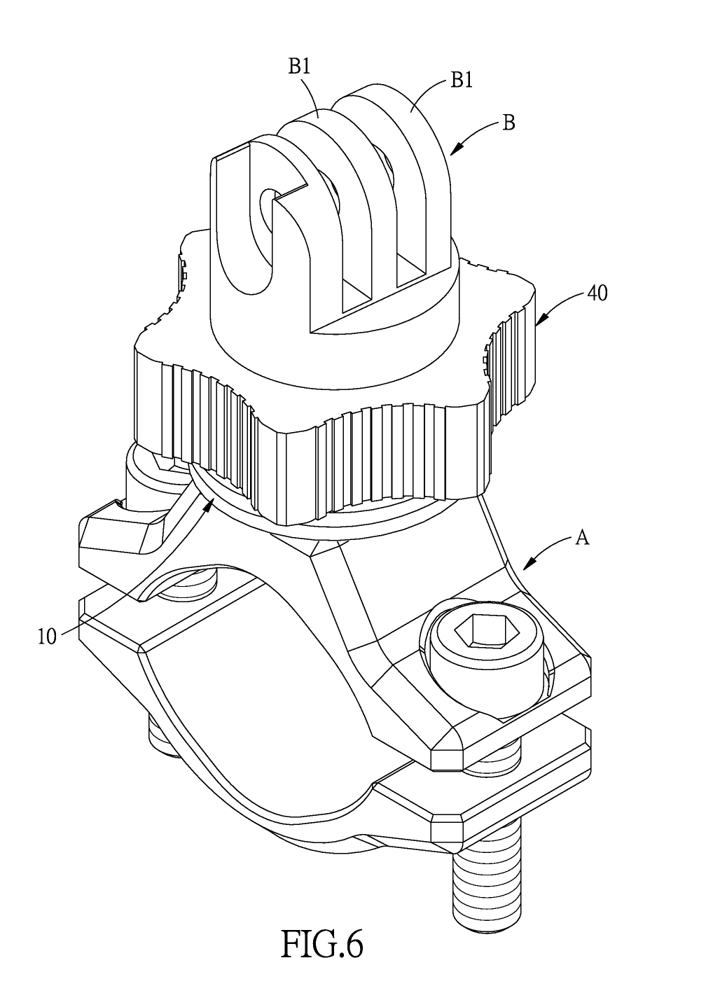

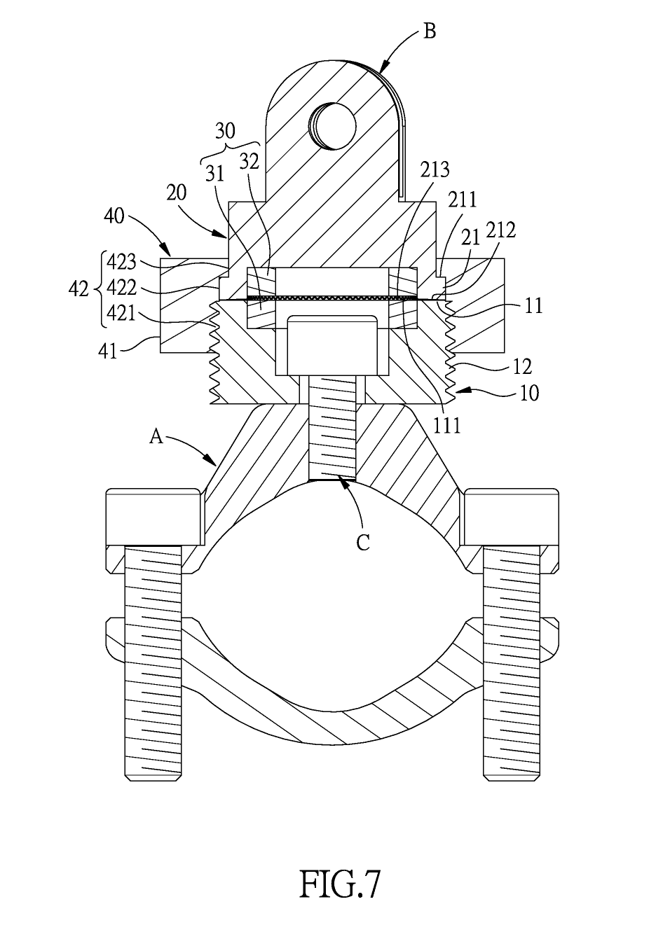

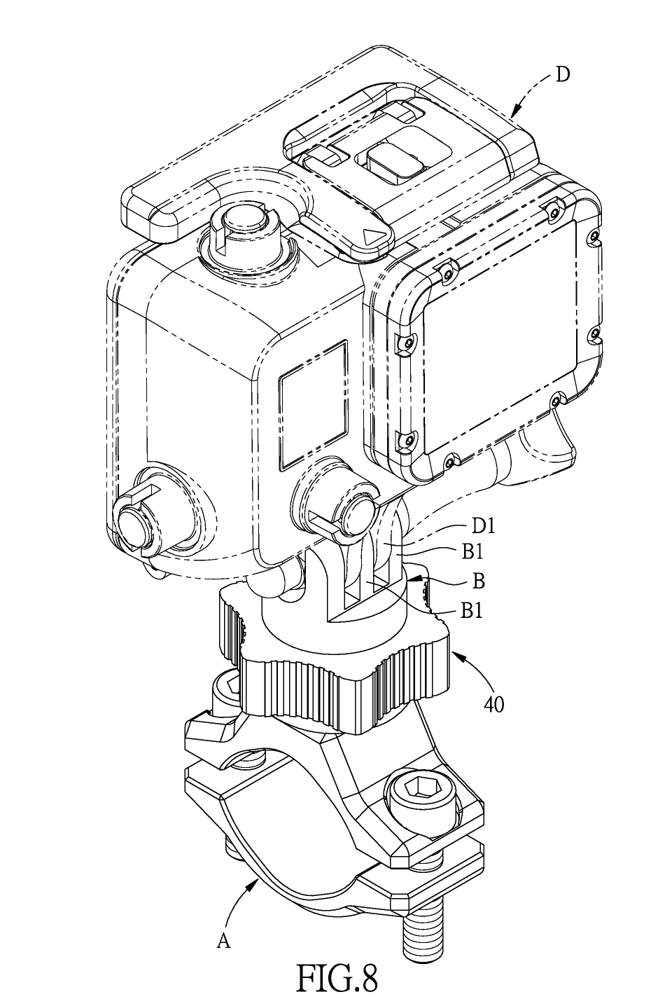

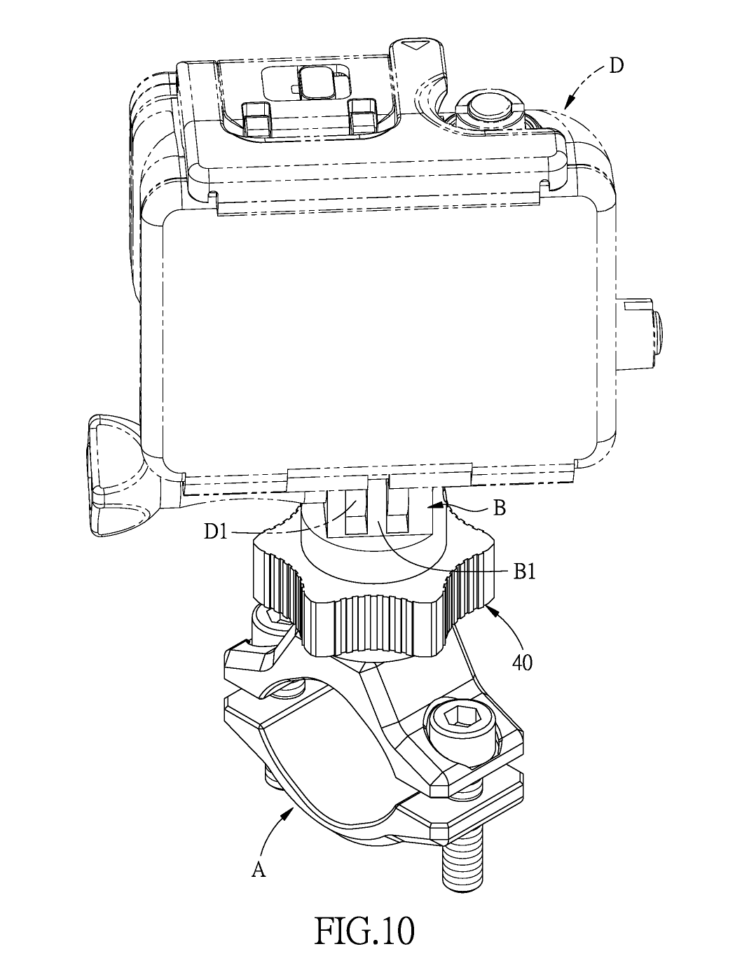

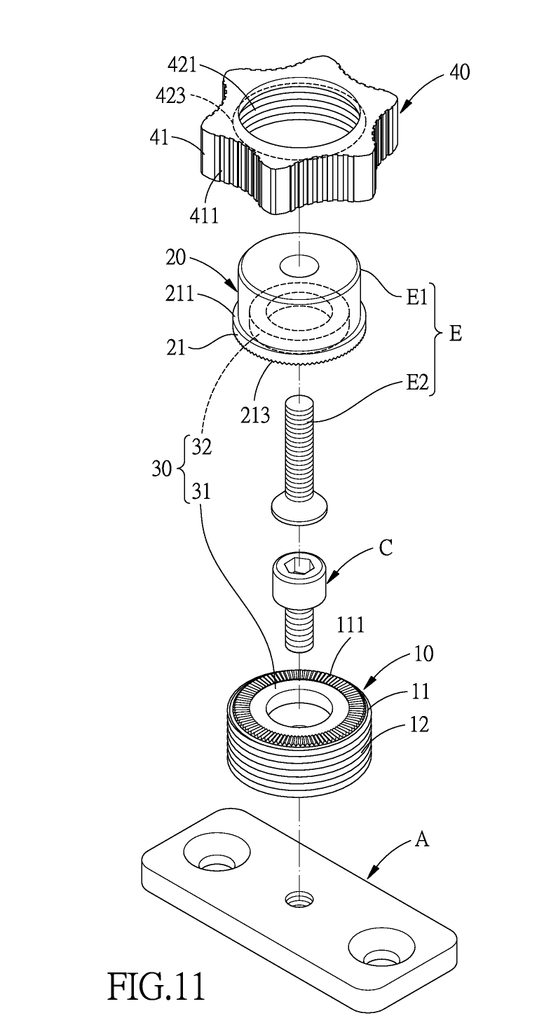

Referring to FIGS. 2-12, a magnetic rotation restricting device in accordance with a preferred embodiment of the present invention comprises: a support unit 10, a rotary unit 20, a magnetic unit 30 and a restricting unit 40.

The support unit 10 is a cylindrical structure which includes a support surface 11 formed at one end thereof, and a threaded surface 12 connected to the support surface 11. The support surface 11 is provided with an annular toothed portion 111, and the threaded surface 12 is formed with a thread. The support unit 10 can be a solid cylindrical structure or a hollow cylindrical structure. The support unit 10 has another end for connecting a support member A which can be an adapter or other object.

The rotary unit 20 has one end formed with an annular flange 21 which includes an abutting surface 211 and an opposite connecting surface 212. The connecting surface 212 is provided with an annular toothed portion 213 for meshing with the toothed portion 111 of the support unit 10. An assembly member B is mounted at another end of the rotary unit 20 and can be an adapter. The connecting surface 212 of the rotary unit 20 is located toward the support surface 11 of the support unit 10. The rotary unit 20 can be a solid cylindrical structure or a hollow cylindrical structure.

The magnetic unit 30 includes at least one magnetic member 31 and a magnetically attracted member 32. The magnetic member 31 is a powerful magnet in this embodiment, and the magnetically attracted member 32 is made of material which is attracted to magnet or magnetic material. The magnetic member 31 and the magnetically attracted member 32 of this embodiment are all magnets which are respectively disposed in the areas defined and surrounded by the annular toothed portions 111, 213. Or, only in the support unit 10 is disposed the magnetic member 31, and the rotary unit 20 is made of magnetically attracted material. Or, only in the rotary unit 20 disposed in the magnetic member 31, and the support unit 10 is made of magnetically attracted material to act as the magnetically attracted member 32. Or, the support unit 10 and the rotary unit 20 are made of magnetic material to act as a magnetic member 31 or a magnetically attracted member 32, so that the support unit 10 and the rotary unit 20 are magnetically attracted to each other.

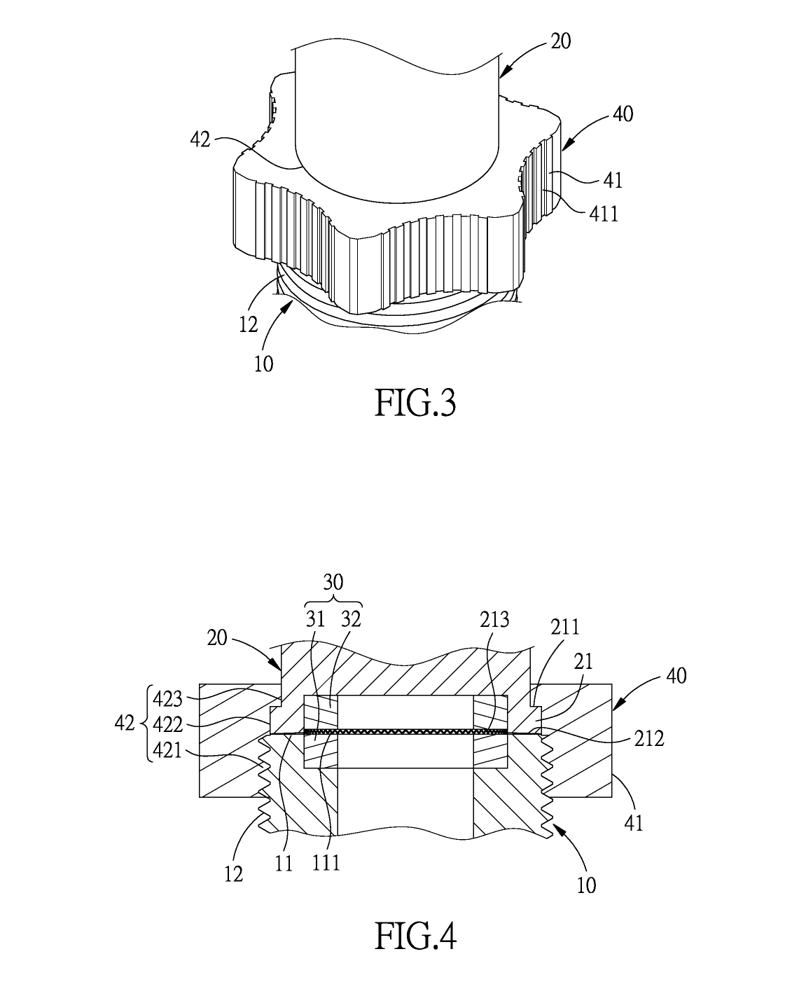

The restricting unit 40 is an annular structure with an outer peripheral surface 41 and an inner peripheral surface 42. The outer peripheral surface 41 is formed with an anti-skid portion 411 in the form of a plurality of grooves. In this embodiment, the outer peripheral surface 41 is in the shape of a hexagram, and the inner peripheral surface 42 has a circular shape and includes a threaded section 421, a transition section 422 and a stop section 423 connected with one another. The threaded section 421 is meshed with the threaded surface 12 of the support unit 10, and the stop section 423 has an inner diameter smaller than that of the threaded section 421. The restricting unit 40 has the inner peripheral surface 42 adjacent to the end of the threaded section 421 sleeved onto the rotary unit 20 and then sleeved onto the support unit 10 to make the threaded section 421 meshed with thread of the threaded surface 12. Rotating the restricting unit 40 makes the stop section 423 move toward the rotary unit 20 until the stop section 423 stops against the abutting surface 211 of the rotary unit 20, as shown in FIG. 3.

When in use, the another end of the support unit 10, and the another end of the rotary unit 20 can be directly integrally formed with an object, then the support surface 11 of the support unit 10 is abutted against the connecting surface 212 of the rotary unit 20, so that the rotary unit 20 and the support unit 10 can be connected to each other by the magnetic force therebetween. Besides, the toothed portion 111 of the support surface 11 of the support unit 10 is also engaged with the toothed portion 213 of the rotary unit 20, so that the support unit 10 and the rotary unit 20 can be roughly assembled and nearly positioned with respect to each other, when the restricting unit 40 is not used.

Then, the restricting unit 40 has the inner peripheral surface 42 adjacent to the end of the threaded section 421 sleeved onto the rotary unit 20 and then sleeved onto the support unit 10 to make the threaded section 421 meshed with thread of the threaded surface 12. After that, rotating the restricting unit 40 makes the stop section 423 move toward the rotary unit 20 until the stop section 423 stops against the abutting surface 211 of the rotary unit 20. At this moment, the restricting unit 40 presses against the rotary unit 20 to prevent disengagement of the rotary unit 20, which also makes the toothed portion 213 of the rotary unit 20 engaged more closely with the toothed portion 111 of the support surface 11 of the support unit 10, so as to prevent relative rotation between the support unit 10 and the rotary unit 20.

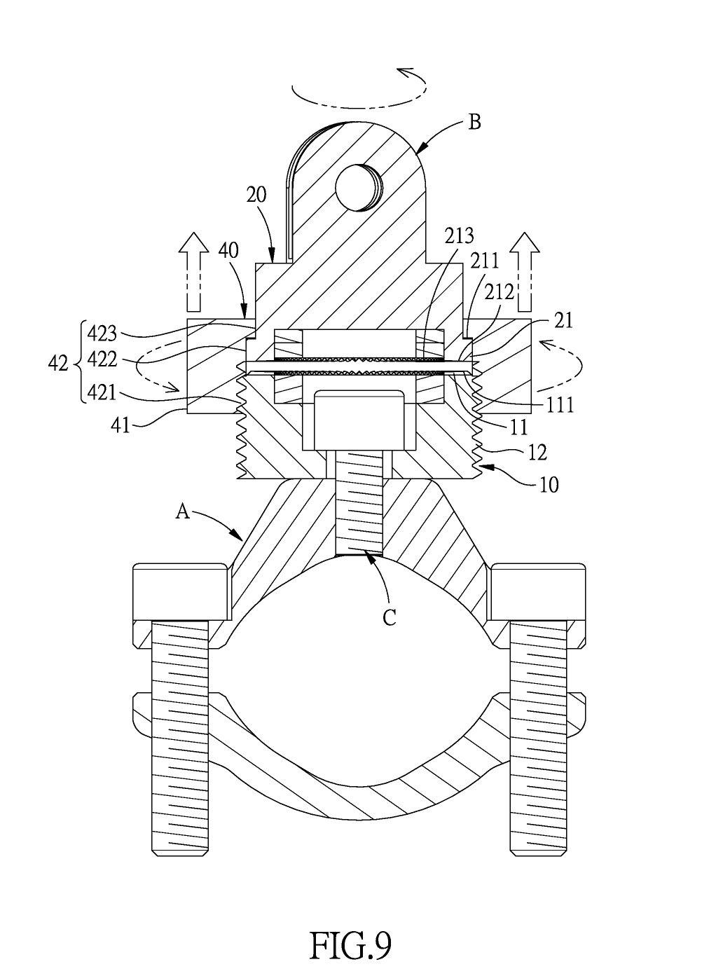

To adjust the angle of the support unit 10 with respect to the rotary unit 20, as shown in FIG. 9, the restricting unit 40 can be unscrewed to move the stop section 423 away from the abutting surface 211 of the rotary unit 20. The rotary unit 20 and the support unit 10 are magnetically attracted to each other by the magnetic unit 30, and therefore won't fall off even when the restricting unit 40 is unscrewed. Then, the user can rotate the rotary unit 20 by pulling the toothed portion 213 of the rotary unit 20 out of the toothed portion 111 of the support unit 10. During the rotation process, the rotary unit 20 won't fall out, as long as the threaded section 421 of the restricting unit 40 is still meshed with the threaded surface 12 of the support unit 10. By such arrangements, the rotary unit 20 is allowed to rotate within a restricted space, so as to be prevented from falling off during rotation. After the angle adjustment is done, all the user has to do is to release the rotary unit 20, then the magnetic unit 30 will attract the rotary unit 20 and the support unit 10 together again.

With the arrangement of magnetic attraction, and the engagement of the toothed portions and the threaded portion, and the restricted space, the structure of the magnetic rotation restricting device in accordance with the present invention is very stable, and is therefore suitable for use in the assembly member B which needs to be used under high speed environment (such as extreme sports). Besides, only the restricting unit 40 needs to be released in order to adjust the angle of the assembly member B, and a restricting force (the magnetic force) will be produced during angle adjustment to prevent inertia-caused uncontrolled rotation of the assembly member B, so as to enhance the precision of adjustment.

FIGS. 2-4 shows that the another end of the support unit 10 opposite the support surface 11 is integrally formed with an object. The another end of the rotary unit 20 opposite the connecting surface 212 is also integrally formed with an object.

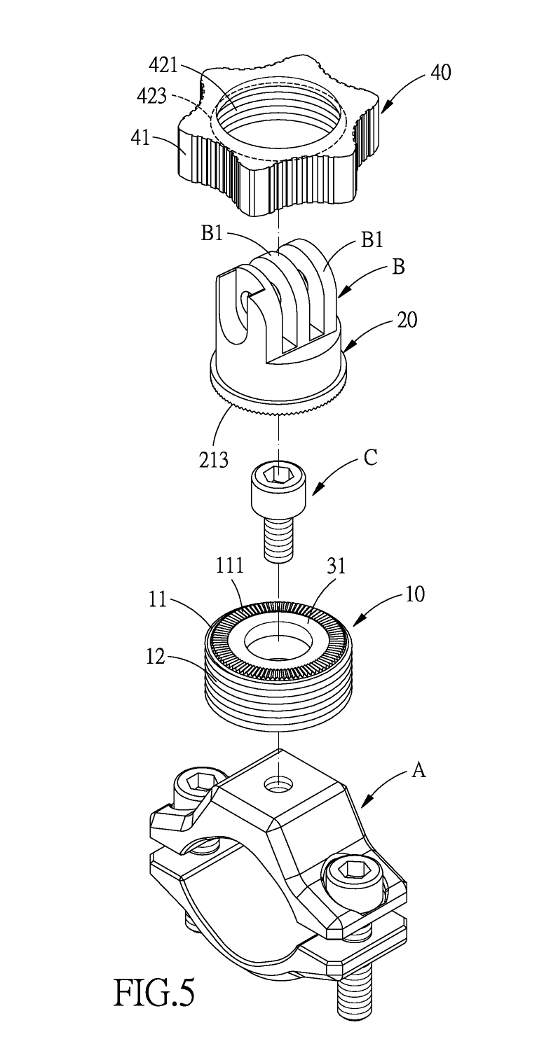

As shown in FIGS. 5-10, the another end of the support unit 10 where the support surface 11 is not located can also be fixed to a support member A (in the form of a pipe clamp) by a bolt C. The another end of the rotary unit 20 opposite the connecting surface 212 is integrally formed with an assembly member B in the form of a pipe clamp seat with a plurality of clamp pieces B1. The support member A in the form of a pipe clamp can be used to clamp a pipe, and the assembly member B with the clamp pieces B1 can be used to fix a component D with a plurality of inserting pieces D1 inserted between the clamp pieces B1.

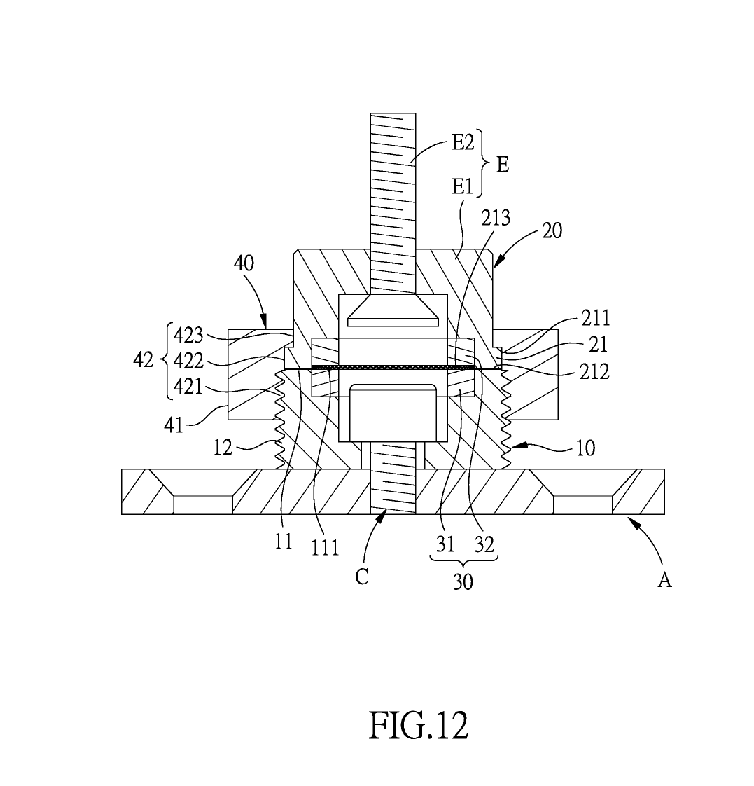

Or, as shown in FIGS. 11-12, the another end of the support unit 10 opposite the support surface 11 is fixed to a laminated support member A, and the another end of the rotary unit 20 opposite the connecting surface 212 is integrally formed with a hollow cylinder portion E1 which is used in combination with a bolt E2 to form another type of assembly member E, so that the bolt E2 is inserted out of the hollow cylinder portion E1 to be fixed to other components.

While we have shown and described various embodiments in accordance with the present invention, it is clear to those skilled in the art that further embodiments may be made without departing from the scope of the present invention.

What is claimed is:

1. A magnetic rotation restricting device comprising:
a support unit with a support surface formed at one end thereof, and a threaded surface connected to the support surface, the support surface being provided with an annular toothed portion, and the threaded surface is formed with a thread, another end of the support unit being connected to a support member;
a rotary unit including one end formed with an annular flange which includes an abutting surface and an opposite connecting surface, the connecting surface being provided with an annular toothed portion for meshing with the toothed portion of the support unit, an assembly member being mounted at another end of the rotary unit, the connecting surface of the rotary unit being located toward the support surface of the support unit;
a magnetic unit enabling the support unit and the rotary unit to be magnetically attracted to each other; and
a restricting unit being an annular structure with an outer peripheral surface and an inner peripheral surface, the inner peripheral surface being circularly shaped and including a threaded section, a transition section and a stop section connected with one another, the threaded section being meshed with the threaded surface of the support unit, and the stop section being smaller in inner diameter than the threaded section, the restricting unit has the inner peripheral surface adjacent to the end of the threaded section sleeved onto the rotary unit and then sleeved onto the support unit to make the threaded section meshed with thread of the threaded surface, rotating the restricting unit makes the stop section move toward the rotary unit until the stop section stops against the abutting surface of the rotary unit.

2. The magnetic rotation restricting device as claimed in claim 1, wherein the magnetic unit includes at least one magnetic member and a magnetically attracted member which are magnets and are respectively disposed in areas defined and surrounded by the annular toothed portions, of the support unit and the rotary unit.

3. The magnetic rotation restricting device as claimed in claim 1, wherein the magnetic unit includes at least one magnetic member and a magnetically attracted member, the magnetic member is a magnet disposed in an area defined and surrounded by the annular toothed portion of the support unit, and the rotary unit is made of magnetically attracted material to act as the magnetically attracted member.

4. The magnetic rotation restricting device as claimed in claim 1, wherein the magnetic unit includes at least one magnetic member and a magnetically attracted member, the magnetically attracted member is disposed in an area surrounded by the annular toothed portion of the rotary unit, and the support unit is made of magnetically attracted material to act as the magnetically attracted member.

5. The magnetic rotation restricting device as claimed in claim 1, wherein the magnetic unit includes at least one magnetic member and a magnetically attracted member, the rotary unit is made of magnet to serve as the magnetic member or the magnetically attracted member, and the support unit is made of magnet to act as the magnetically attracted member or the magnetic member.

6. The magnetic rotation restricting device as claimed in claim 1, wherein the outer peripheral surface is formed with an anti-skid portion in the form of a plurality of grooves.

7. The magnetic rotation restricting device as claimed in claim 1, wherein the outer peripheral surface is in the shape of a hexagram.
